(19) United States
(12) Patent Application Publication
(10) Pub. No.: US 2005/0016831 A1
(43) Pub. Date: Jan. 27, 2005

(54) Generation of acetylene for on-site use in carburization and other processes

(76) Inventors: Joseph E. Paganessi, Burr Ridge, IL (US); Frederick W. Giacobbe, Naperville, IL (US)

Correspondence Address: Linda K. Russell;Patent Counsel, Air Liquide, 2700 Post Oak Blvd., Suite 1800, Houston, TX, 77056, US

(21) Appl. No.: 10/813,557

(22) Filed: Mar. 31, 2004

Related U.S. Application Data
(60) Provisional application No. 60/489,813, filed on Jul. 24, 2003.

(51) Int. Cl. C22B 34/30; B01J 19/08

(52) U.S. Cl. 204/164; 422/186

(57) ABSTRACT

An acetylene generation and supply system includes an acetylene generation device configured to generate acetylene from at least one reactant feed stream including at least one carbon containing material, and an acetylene processing device oriented in-line and downstream from the acetylene generation device to receive and process generated acetylene from the acetylene generation device. The acetylene processing device consumes at least a portion of the generated acetylene upon operation of the acetylene processing device. In one embodiment, the acetylene generation device is an arc plasma reactor, and the acetylene processing device is a carburization system that processes steel parts.

### CROSS-REFERENCE TO RELATED APPLICATIONS

This application claims priority from U.S. Provisional Patent Application Ser. No. 60/489,813, entitled “On-site Generation of Acetylene For Carburization”, and filed Jul. 24, 2003. The disclosure of this provisional patent application is incorporated herein by reference in its entirety.

### BACKGROUND OF INVENTION

1. Field of Invention

The present invention pertains to generating acetylene for direct on-site use in a process such as carburization.

2. Related Art

Acetylene, also referred to as ethyne, is used in a number of processes including oxyacetylene welding/cutting and steel hardening or carburization. In particular, acetylene has been determined within the last decade to be one of the best hydrocarbons for use in vacuum and plasma carburization processes.

Acetylene is typically produced in bulk quantities and stored in tanks or cylinders for use in processes such as carburization. Acetone must also be provided within the cylinders (e.g., in a packed porous material disposed within the cylinders), particularly when the cylinders are stored at higher pressures, to prevent the spontaneous and violent decomposition of acetylene into hydrogen and carbon compounds. The problem associated with providing acetone in the cylinders is that the acetone can be entrained in the acetylene being delivered to the process. This reduces the purity of the acetylene and can lead to problems in the process. For example, it is important to minimize or eliminate the presence of oxygen in a carburization process so as to prevent surface oxidation of the components being treated. However, any acetone entrained in the acetylene delivered to the vacuum carburization process may generate oxygen and/or excessive soot within the carburization chamber as the acetone decomposes.

### SUMMARY OF THE INVENTION

Accordingly, it is an object of the present invention to provide acetylene at a high purity level for use in a process such as carburization.

It is another object of the present invention to provide acetylene for a process where acetone contamination of the acetylene is mitigated or avoided.

The aforesaid objects are achieved individually and/or in combination, and it is not intended that the present invention be construed as requiring two or more of the objects to be combined unless expressly required by the claims attached hereto.

In accordance with the present invention, an acetylene generation and supply system includes an acetylene generation device configured to generate acetylene from at least one reactant feed stream including at least one carbon containing material, and an acetylene processing device oriented in-line and downstream from the acetylene generation device to receive and process generated acetylene from the acetylene generation device. The acetylene processing device consumes at least a portion of the generated acetylene upon operation of the acetylene processing device.

In a preferred embodiment, the acetylene generation device is an arc plasma reactor, and the acetylene processing device is a carburization system that treats steel components. Any one or combination of carbon containing materials can be provided in one or more feed streams to the acetylene generation device including, without limitation, natural gas, coal, methane and C₂-C₈ alkyl and/or aryl hydrocarbons (in liquid or gaseous form).

The above and still further objects, features and advantages of the present invention will become apparent upon consideration of the following detailed description of specific embodiments thereof.

### BRIEF DESCRIPTION OF THE DRAWINGS

FIG. 1 is a schematic of a combined, on-site and in-line acetylene plasma generation and vacuum carburization system in accordance with the present invention.

### DESCRIPTION OF PREFERRED EMBODIMENTS

Carburization of steel components or parts (e.g., automotive components such as gears, sprockets, nozzles, valves, etc.) is typically carried out in a process chamber (e.g., a furnace). The steel parts are loaded into the chamber, the chamber is heated, and a hydrocarbon gas (e.g., acetylene, propane, etc.) is introduced into the chamber to facilitate carbon absorption and strengthening of the steel parts while at the elevated carburizing temperature.

Acetylene has been determined over recent years to be highly effective in carburization processes. This is due, at least in part, to the dissociation characteristics of acetylene under low pressure conditions in comparison to propane and other hydrocarbons, which in turn results in higher carbon availability for absorption by the steel parts. The use of acetylene during a carburization process ensures uniform carburization of steel parts having complex geometries and/or being densely packed in the chamber.

Vacuum and plasma carburization are two well known and commonly used carburization methods utilized today to treat steel components. However, other carburization methods are also available, including atmosphere (gas), liquid and pack carburizing methods.

Vacuum carburization is preferably carried out under low pressure vacuum conditions (e.g., no greater than about 2 kPa) to avoid excess soot formation within the process chamber. The general steps in a vacuum carburization process include the following: (a) loading the steel parts into a process chamber (e.g., a furnace); (b) heating and soaking the steel parts at a suitable carburizing temperature (e.g., about 845° C. to about 1040° C.) to ensure temperature uniformity throughout the parts; (c) filling the chamber with a hydrocarbon gas (e.g., acetylene) at the carburizing temperature to facilitate dissociation or decomposition of the gas and absorption of carbon atoms at the surfaces of the steel parts; (d) maintaining the steel parts in the chamber at the carburizing temperature for a sufficient time to facilitate diffusion of carbon inward from the carburized surface of each steel part; and (e) quenching of the steel parts (e.g., in oil). In addition, steps (b)-(e) can be repeated for any number of selected cycles depending upon the degree of carburization treatment necessary for a particular application.

Plasma carburization is similar to vacuum carburization as described above, with the exception that the hydrocarbon gas is decomposed by plasma arc generation to facilitate absorption and diffusion of carbon atoms into the steel surfaces of the steel parts.

The process chamber for the vacuum carburization process can consist of a single chamber or, alternatively, include a series of two or more sub-chambers, that facilitate heating, carburizing and quenching of the treated parts or components according to the method described above. Exemplary embodiments of vacuum carburizing systems with processing chambers that may be used in accordance with the present invention include, without limitation, systems described in the following published documents: Surface Hardening: Understanding the Basics (J. R. Davis, Ed., pp. 91-114, ASM International, 2002), An Update on Low Pressure Carburizing Techniques and Experiences (available from Ipsen International, Inc., Cherry Valley, Ill.), and U.S. Pat. Nos. 5,702,540 and 5,722,825. The disclosure of each of these published documents is incorporated herein by reference in its entirety.

As noted above, acetylene is volatile and unstable, particularly at high pressures, and must be combined with acetone to prevent its spontaneous decomposition during long term storage (e.g., when stored in cylinders for delivery and use from a production facility to an end-use process). However, the acetone can become entrained with acetylene, thus reducing the purity of the acetylene being delivered for use in a particular process. For carburization, the presence of acetone in the acetylene feed will result in an undesired introduction of oxygen into the process chamber when the acetone decomposes with the acetylene at the carburization temperatures.

This problem is avoided, in accordance with the present invention, by providing an acetylene generation system on-site and in-line with a carburization or other acetylene processing system so as to facilitate generation of acetylene and delivery of the acetylene directly to the acetylene processing system. The term “on-site”, as used herein, refers to acetylene being produced at the same facility and location in which the acetylene is utilized in a particular process. The term “in-line”, as used herein, refers to the acetylene generation system and the acetylene processing system being combined into a single system such that acetylene is generated and then subsequently consumed (e.g., in a carburizing process, an oxyacetylene welding/cutting process, etc.). The consumption of acetylene in the acetylene processing system can be partial or complete and can occur by reaction of the acetylene with other compounds and/or decomposition of acetylene.

The generated acetylene can also be stored in cylinders at lower pressures (e.g., at vacuum carburizing pressures) for a short time period and without the need for providing acetone in the cylinders prior to being used by the acetylene processing system. The cylinders can be disposed in-line between the acetylene generation and processing systems or, alternatively, removed from the systems so as to be connected and disconnected during charging and discharging of the cylinders.

Any suitable technique and associated processing equipment may be employed for generating acetylene for use in carburization or other processes. For example, acetylene can be generated by any of the following techniques: reaction of calcium carbide and water to yield acetylene (with calcium oxide as a by-product), reaction of methane, propane, butane or any other suitable hydrocarbon with a suitable oxidant (e.g., oxygen) to yield acetylene (with hydrogen and water as by-products), and plasma arc generation of a hydrocarbon to yield acetylene (with hydrogen as a by-product). The preferred method of generating acetylene is plasma arc generation because the products yielded by this method do not include oxygen and thus do not require any additional processing to remove the oxygen prior to delivery to the carburization or other process.

Any one or combination of suitable carbon containing materials can be utilized in the plasma arc generation process to produce acetylene including, without limitation, methane, coal, and C₂-C₈ alkyl and/or aryl hydrocarbons (in liquid or gaseous form). For example, natural gas, which primarily includes a combination of hydrocarbons (e.g., about 70-90% methane, about 0-20% ethane, propane and/or butane), and a balance including carbon dioxide (e.g., about 0-8%), oxygen (0-0.2%), nitrogen (0-5%), hydrogen sulfide (0-5%), and trace amounts of rare gases (e.g., helium, argon and neon), can be used as the reactant feed to the plasma reactor. In an exemplary embodiment, methane is introduced into the plasma reactor to yield acetylene and hydrogen according to the following equation:
2CH₄->C₂H₂+3H₂
Any conventional or other suitable plasma arc reactor may be utilized to convert the hydrocarbon(s) to acetylene. Exemplary embodiments of plasma arc reactors suitable for use in the present invention are described in U.S. Pat. Nos. 4,105,888 and 4,190,636, the disclosures of which are incorporated herein by reference in their entireties. Generally, the plasma arc reactor can include an anode portion and a cathode portion disposed within the reactor, and a suitable electrical circuit including a power supply connecting the electrodes. A discharge of high voltage and high frequency (e.g., from about 3,000 volts to about 30,000 volts at about four megahertz for about 0.5 second) between the electrodes initiates an arc to generate plasma which heats the carbon containing material(s) introduced into the reactor, resulting in the production of acetylene. After generation of an initial arc, much lower voltages can be provided between the electrodes to sustain a continuous plasma arc within the reactor.

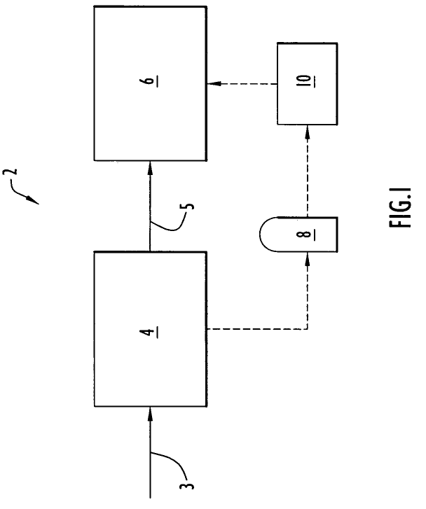

An exemplary system for generating acetylene for delivery to a carburization process is schematically depicted in FIG. 1. In particular, system 2 includes a plasma arc reactor 4 (e.g., similar to the reactor described above) disposed upstream and in-line with a vacuum carburization chamber 6 (e.g., similar to any of the previously described vacuum carburization systems) via a supply conduit 5. The reactor 4 includes an anode, a cathode and an electrical circuit including a suitable power supply (e.g., rated at about 10 kW to about 1000 kW, preferably about 50 kW to about 500 kW). A reactant supply conduit 3 is connected at an inlet to reactor 4 to facilitate the supply of a reactant feed into the reactor 4 from a feed source (not shown). The reactant feed can include any one or more carbon containing materials as described above. An outlet of the reactor 4 is secured to one end of the supply conduit 5. Similarly, an inlet to chamber 6 is secured to an opposing end of the supply conduit 5.

Alternatively, or in addition to the plasma arc reactor 4, any other suitable acetylene generation system may be situated upstream and in-line with the vacuum carburization chamber 6. However, in systems where an acetylene generation system utilizes an oxidant and/or generates by-products that include oxygen or other undesired materials in addition to acetylene, separation or purification units are also preferably included in-line and between the outlet of the acetylene generation system and the inlet of the vacuum carburization chamber to facilitate removal of such by-products from the generated acetylene prior to delivery for use in the carburization process.

In operation, the reactant feed, including one or more carbon containing materials (e.g., methane), is delivered into the reactor 4, and an arc is generated and maintained between the anode and cathode disposed within the reactor by the power supply, which in turn generates a plasma that results in the formation of acetylene and by-products (e.g., hydrogen). The generated acetylene (if purified) or acetylene with by-products are delivered, via conduit 5, to the vacuum carburization chamber 6. The chamber 6 is loaded with steel parts and heated to a suitable temperature, as described above, to facilitate decomposition of acetylene and absorption and diffusion of carbon into the surfaces of the steel parts. The parts are then quenched and, optionally, subjected to additional heat treatment/carburizing cycles and/or other suitable processing steps.

The reactor 4 may be operable to provide a continuous supply of generated acetylene product to the chamber 6 at a desired flow rate during the carburization treatment process. Alternatively, any suitable number of storage cylinders may be provided in-line between the outlet of the reactor 4 and the inlet of the chamber 6 (as generally indicated by cylinder 8 in FIG. 1) to temporarily store the generated acetylene product at suitable low pressures (e.g., at about the same pressure as the operating pressure within the chamber 6) between periods in which the carburization process is implemented (e.g., during loading and unloading of steel parts into the chamber 6). Rather than being disposed in-line, the storage cylinders may be engaged with the reactor 4 to fill or charge the cylinders with acetylene and then subsequently disengaged with the reactor 4 and engaged with the chamber 6 to discharge the cylinders so as to fill the chamber 6 with a suitable amount of acetylene at a suitable flow rate.

Since the acetylene is stored temporarily at low pressures and will be used once the carburization chamber is operational, it is not necessary to provide acetone in the storage cylinders. However, the acetylene may also be stored at higher pressures, with porous media including acetone being disposed within the cylinders to prevent decomposition of the acetylene. In such a situation, the acetylene is preferably purified to remove acetone prior to delivery to the chamber 6. Accordingly, the system 2 facilitates adequate generation and supply of acetylene on-site and in-line for use in the carburization chamber 6.

Optionally, the system 2 may further include any one or more conventional purification units (indicated generally by unit 10 in FIG. 1) disposed in-line between the reactor 4 and the carburization chamber 6 to purify the generated acetylene (e.g., remove acetone, undesired by-products and/or unconsumed feed products from the acetylene) prior to being utilized in the carburization process. Examples of purification units suitable for use in the present invention include, without limitation, filters, adsorption beds, diffusion membranes, and/or cryogenic separators. If used in combination with storage cylinders, the purification units are preferably disposed downstream from the cylinders.

As noted above, the present invention further includes the combination of acetylene generation with other processes in addition to carburization processes. For example, an alternative embodiment of the present invention utilizes an acetylene generation system (e.g., an arc plasma reactor as described above) in combination with an oxyacetylene welding and/or cutting device. In such a system, the generated acetylene (if purified) or the acetylene and by-products can be delivered for immediate use by the welding/cutting device or, alternatively, delivered to cylinders for short term storage at low pressures prior to delivery to the welding/cutting device. In general, any process requiring acetylene can be combined with an acetylene generation system in accordance with the present invention.

Having described novel acetylene generation systems for on-site use in carburization and other processes, it is believed that other modifications, variations and changes will be suggested to those skilled in the art in view of the teachings set forth herein. It is therefore to be understood that all such variations, modifications and changes are believed to fall within the scope of the present invention as defined by the appended claims.

1. An acetylene generation and supply system comprising:
an acetylene generation device configured to generate acetylene from at least one reactant feed stream including at least one carbon containing material; and
an acetylene processing device oriented in-line and downstream from the acetylene generation device to receive and process generated acetylene from the acetylene generation device so as to consume at least a portion of the generated acetylene upon operation of the acetylene processing device.

2. The system of claim 1, wherein the acetylene generation device comprises an arc plasma reactor including an anode and a cathode disposed within the reactor, and a power source connected to the anode and the cathode to generate plasma within the reactor.

3. The system of claim 1, wherein the process device comprises a carburization device including at least one chamber to receive and process steel components, the carburization device being configured to perform a carburization process including heat treating and quenching the steel components.

4. The system of claim 1, wherein the at least one carbon containing material is at least one of natural gas, coal, methane and C₂-C₈ alkyl and/or aryl hydrocarbons.

5. The system of claim 1, wherein the at least one carbon containing material comprises methane.

6. The system of claim 1, further comprising:
at least one storage cylinder connectable with the acetylene generation device to received and store acetylene generated by the acetylene generation device.

7. The system of claim 6, wherein the at least one storage cylinder is free of acetone.

8. The system of claim 6, wherein the at least one storage cylinder is disposed in-line between the acetylene generation device and the acetylene processing device.

9. The system of claim 1, further comprising:
a purification unit disposed in-line between the acetylene generation device and the acetylene processing device.

10. A method of generating and supplying acetylene, comprising:
generating acetylene in an acetylene generation device by directing at least one reactant feed stream including at least one carbon containing material into the acetylene generation device;
directing the generated acetylene to an acetylene processing device disposed in-line and downstream from the acetylene generation device; and
operating the acetylene processing device to consume at least a portion of the acetylene.

11. The method of claim 10, wherein the acetylene generation device comprises an arc plasma reactor including an anode and a cathode disposed within the reactor, and the acetylene is generated by generating plasma within the reactor via a power supply connected to the anode and the cathode.

12. The method of claim 10, wherein the process device comprises a carburization device, and operation of the carburization device comprises:
receiving and heat treating steel components within at least one chamber of the carburization device;
introducing the generated acetylene into the at least one chamber to facilitate absorption and diffusion of carbon at the steel components.

13. The method of claim 10, wherein the at least one carbon containing material is at least one of natural gas, coal, methane and C₂-C₈ alkyl and/or aryl hydrocarbons.

14. The method of claim 10, wherein the at least one carbon containing material comprises methane.

15. The method of claim 10, further comprising:
prior to directing the generated acetylene to an acetylene processing device, storing the generated acetylene in at least one storage cylinder.

16. The method of claim 15, wherein the at least one storage cylinder is disposed in-line between the acetylene generation device and the acetylene processing device.

17. The method of claim 15, wherein the at least one storage cylinder is free of acetone.

18. The method of claim 10, further comprising:
directing the generated acetylene through at least one purification unit prior to prior to directing the generated acetylene to an acetylene processing device.

19. An acetylene generation and supply system comprising:
a means for generating acetylene utilizing from at least one feed stream including at least one carbon containing material; and
a means for consuming at least a portion of the generated acetylene;
wherein the means for consuming is disposed in-line and downstream from the means for generating acetylene.
